(19) United States
(12) Patent Application Publication
(10) Pub. No.: US 2013/0260073 A1
(43) Pub. Date: Oct. 3, 2013

(54) Toilet Paper with Protective Thumb Pockets

(71) Applicant: J.B. O'Daniel, Duncanville, TX (US)

(72) Inventor: J.B. O'Daniel, Duncanville, TX (US)

(21) Appl. No.: 13/437,595

(22) Filed: Apr. 2, 2012

(51) Int. Cl. A47K 10/16; B32B 29/00; B32B 3/14

(52) U.S. Cl. 428/43; 428/77; 428/78

(57) ABSTRACT

A toilet paper product is formed as a continuous length of toilet tissue having a first side and an oppositely arranged second side, the length of tissue being wrapped about a cylindrical core to form a roll. The continuous length of toilet tissue has a series of thumb receiving pockets located at spaced intervals along the first side thereof, whereby upon dispensing a selected length of toilet paper from the roll, a user's thumb can be placed within a selected pocket with remaining fingers of the user's hand being located behind the selected length of tissue against the second side thereof, so that the user's hand is protected from contamination during use.

### BACKGROUND OF THE INVENTION

A. Field of the Invention

The present invention relates generally to a toilet paper product and, more specifically, to a toilet paper product having protective thumb pockets which lessen the chance of contamination of a user's hand during use.

B. Description of the Prior Art

A variety of disposable paper products are commercially available at the present time for use in a myriad of different cleaning, handling, polishing and wiping tasks. These products include paper napkins, towels and facial tissues to name a few. Sanitary tissue products, generally referred to as bathroom tissue, toilet tissue or toilet paper products, are another such familiar household item. This type of product is often provided as a one or two ply product, made of either ordinary or high density paper. These types of household products are usually made and marketed in roll form with individual sheets of the tissue being defined by perforations extending across the width of the product. The product is typically wound lengthwise on a hollow cardboard cylinder or core to form a roll of paper and packaged in single or multiple roll configurations.

The following references are intended to be representative of the general state of the toilet paper making arts, as well as illustrating certain other paper cleaning and polishing products which have hand-receiving openings provided thereon:

U.S. Pat. No. 1,731,340 shows a piece of tissue paper which is folded to form a sort of mitt which can be used as a glove by attendants in hospitals, or the like, to prevent contact with germ contaminated areas. The fingers of the hand are received within a pocket of the mitt. This particular type of tissue paper appears to be of the kind that would be dispensed from box or other enclosure, rather than being provided on a roll in a continuous strip.

U.S. Pat. No. 5,972,456 shows a type of toilet paper product having a particular thickness which is great enough to allow the product to be used without folding prior to use.

U.S. Pat. No. 8,097,322 shows a toilet paper product which includes both a dry section and a wet companion section.

U.S. Pat. No. 5,127,127 shows a hand-held paper wipe which includes a pocket for the four fingers.

U.S. Pat. No. 5,473,789 shows a disposable toilet cleaning pad which includes a space for the user's hand.

U.S. Pat. No. 5,649,336 shows a mitten-type wipe which would again be dispensed from a box like tissue paper and which includes a mitt body having an opening to receive the user's fingers.

U.S. Pat. No. 5,799,331 shows a hand protector with spaces for the user's hand and finger (see FIG. 2).

U.S. Pat. No. 5,019,058 shows an applicator mitt having a treating portion which receives the user's hand and a protective cover which is removable to expose the treated portion of the mitt during use.

It will be appreciated from the above exemplary prior art references that the prior art teaches two or more ply toilet paper and various other paper products having multiple layers. Some paper goods apart from the toilet paper arts show pockets or regions for receiving a portion of a user's hand during use. However, the prior art does not teach a toilet paper product in the form of a continuous roll which has thumb receiving pockets formed along the continuous length thereof for protecting the user's thumb and hand in use.

A need exists, therefore, for an improved toilet paper product which provides enhanced protection for a user's hand in use, thereby avoiding or lessening the possibility of contact with germs or other contamination.

Additionally, many of the prior art products, although furnished in folded or rolled states for storage or dispensing, all ultimately tend to wrinkle, bunch up and tear during use. Conventional toilet paper is one example of a paper product which exhibits all of the foregoing problems, yet having remained basically unchanged in design for many years.

A need also exists, therefore, for an improved toilet paper product which, due to its unique design, would provide an active wiping surface which would tend to remain generally flat in use, without bunching up or tearing, while also offering an improved protective cover for the hand of the user.

### SUMMARY OF THE INVENTION

A primary objective of the present invention is to provide a soft, absorbent toilet paper product having advantages not taught by the prior art.

Another objective is to provide a toilet paper product that is improved over the prior art but still compatible with conventional toilet paper roll holders or dispensers.

Another objective is to provide a toilet paper product that has features which allow it to be grasped and used with less danger of contamination of the user's hand.

The improved toilet paper of the invention is formed so that a series of pockets are attached at spaced intervals along the length of the normal roll. This arrangement allows a user to insert a thumb into a selected pocket with the user's fingers being located behind a rear face of the normal length of paper to create a kind of hand wrap which protects the hand and thumb during use. The four fingers of the hand go under the normal continuous length of paper while the thumb goes inside of the looped piece of paper which forms the pocket on the opposite, exposed surface of the paper as it comes off the roll.

An improved toilet paper product is therefore shown which is designed to be dispensed into the hand of a user. The improved toilet paper product is formed as a continuous length of toilet tissue having a first side and an oppositely arranged second side, the continuous length of toilet tissue being wrapped about a cylindrical core to thereby form a roll of toilet paper. The continuous length of toilet tissue has a series of thumb receiving pockets located at spaced intervals along the first side thereof, whereby upon dispensing a selected length of toilet tissue from the roll, a user's thumb can be placed within a selected pocket with remaining fingers of the user's hand being located behind the selected length of tissue against the second side thereof, so that the user's hand is protected from contamination during use.

The pockets have side edges which define a width measured from the sides of the continuous length of toilet tissue and a length measured along the length of the tissue, and wherein the width of the pockets is less than the width of the continuous length of toilet tissue so that the side edges of the pockets are spaced apart from adjacent edges of the continuous length of toilet tissue.

Preferably, each pocket is partly folded over itself and pressed down flat onto the first side of the continuous length of toilet tissue, whereby each pocket tends to expand into a tent like opening as the toilet tissue is dispensed from the roll. This makes it easier for a user to insert the thumb into the pocket during use. Also, two different textures of paper are preferably used for the continuous length of tissue paper and the thumb receiving pockets so that the pockets and the continuous length of tissue paper do not tend to mesh together.

The thumb receiving pockets are preferably pressure pressed onto the continuous length of toilet tissue along top and bottom edges thereof with a serrated press in order to hold the pockets onto the continuous length of tissue. The continuous length of toilet tissue will also typically be provided with a plurality of perforations at spaced intervals which form a series of linear tearing portions, the perforations allowing the product to be easily torn into desired lengths.

Additional objects, features and advantages will be apparent in the written description which follows.

### BRIEF DESCRIPTION OF THE DRAWINGS

FIG. 1 is a perspective view of a typical bathroom toilet and toilet paper holder arrangement, showing the toilet paper of the invention on the holder.

FIG. 2 is a front view of one sheet of the toilet paper of the invention showing the thumb receiving pocket.

FIG. 3 is a side view of the sheet of toilet paper of the invention showing the crease of the thumb receiving pocket, whereby the pocket folds back upon itself in a relaxed condition.

FIG. 4 is a view of a user's hand prior to grasping the toilet paper of the invention.

FIG. 5 illustrates the use of the improved toilet paper of the invention, showing the positioning of the user's thumb and remaining four fingers with respect to one sheet of toilet paper.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

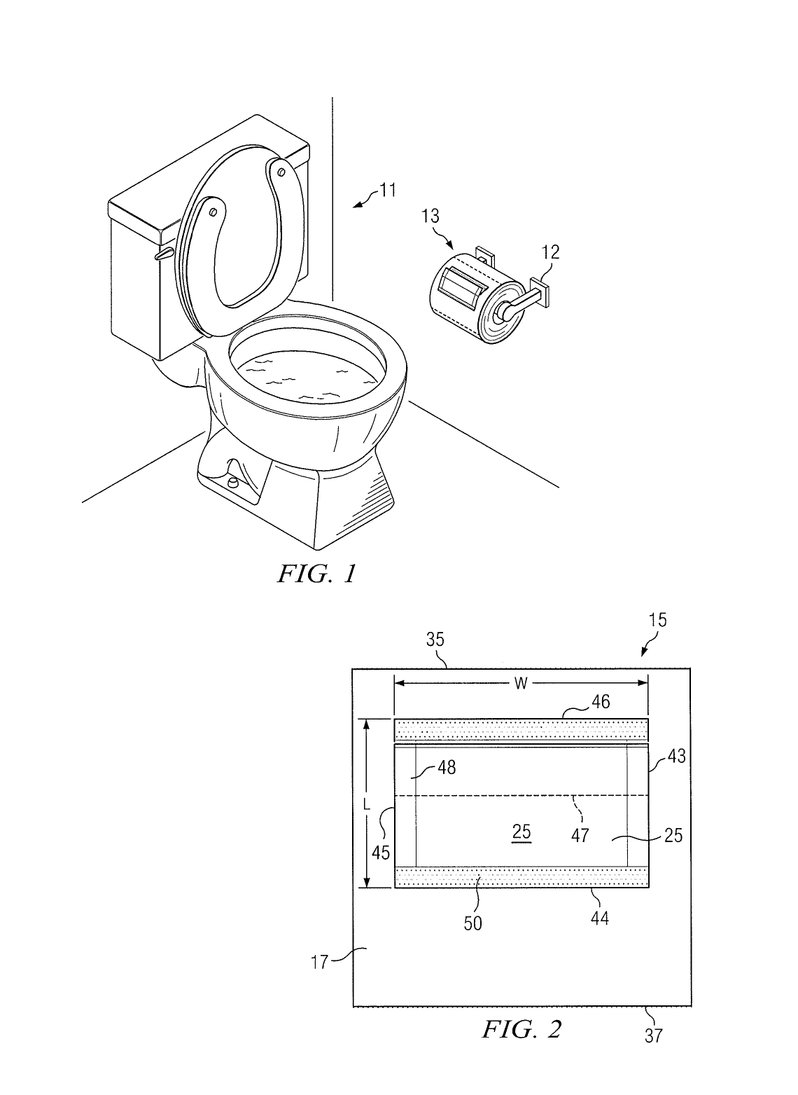

With reference now to the drawings, and in particular to FIG. 1 thereof, there is shown a typical bathroom toilet installation 11 including a toilet paper holder 12 equipped with a roll of improved toilet paper product 13 of the invention.

With reference to FIG. 2 of the drawings, there is shown one sheet of the improved toilet paper product of the invention, designated generally as 15. As will be explained in greater detail in the description which follows, the toilet paper product 15 is designed to be dispensed into the hand of a user.

The toilet paper product 13 is preferably provided in the form of a continuous length of toilet tissue (as will be appreciated from FIG. 5) having a first side 17 and an oppositely arranged second side 19. The continuous length of toilet tissue is wrapped about a cylindrical core 21 (typically formed of cardboard) to thereby form a roll of toilet paper.

As can be seen in FIG. 5, the continuous length of toilet tissue has a series of thumb receiving pockets 23, 25, 27 located at spaced intervals along the first side 17 thereof. Upon dispensing a selected length of toilet tissue from the roll, a user's thumb 29 can be placed within a selected pocket 25 with remaining fingers 31 of the user's hand being located behind the selected length of tissue against the second side 19 thereof, so that the user's hand is protected from contamination during use.

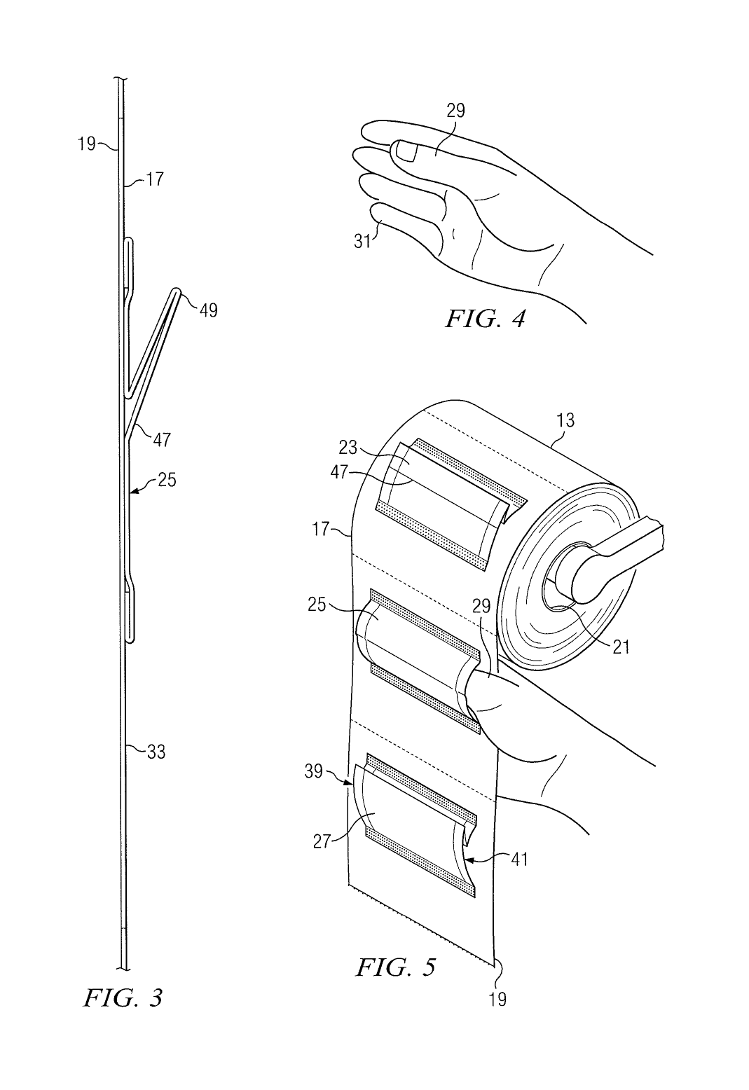

With reference to FIGS. 2 and 3, the toilet paper product of the invention is shown in greater detail. The pocket 25 is affixed atop a single sheet of the tissue 33, defined between the perforated tear lines 35, 37. Pockets may be formed on each sheet, on every other sheet, on every third sheet, etc., as desired. Each pocket has two opposing ends (such as ends 39, 41 in FIG. 5). At least one end (such as end 41) terminates in an end opening for receiving a user's thumb.

It will be appreciated with respect to FIG. 2, that each of the pockets has edges 43, 45 which define a width “W” measured from the sides of the continuous length of toilet tissue and a length “L” measured along the length of the tissue. The width “W” of the pockets is preferably less than the width of the continuous length of toilet tissue so that the side edges 43, 45 of the pockets are spaced apart from adjacent edges of the continuous length of toilet tissue. This spacing facilitates the user's ability to grasp the pocket interior during use.

As can be seen in FIG. 3, each pocket is partly folded over itself and pressed down flat onto the first side of the continuous length of toilet tissue to create a crease line 47 and flap 49. The flap folds flat against the first exposed surface 17 of the length of tissue in the relaxed state (as in storage on the roll). As best seen in FIG. 5, as a sheet of paper is pulled from the roll, each pocket tends to expand into a “tent like” opening as the toilet paper product is dispensed from the roll. By “tent like” is meant an inverted “V” or apex shape. This aspect of the product design again facilitates the user's ability to easily grasp the pocket during use. Also, the use of two different textures of paper for the continuous length of tissue paper and the thumb receiving pockets is preferred so that the pockets and the continuous length of tissue paper do not tend to mesh together as packaged on the roll. For example, the thumb protector might be only one ply while the underlying sheet of paper might be three ply.

The paper stock from which the toilet paper product of the invention is constructed is of conventional design and can even be commercially purchased. The paper stock may be made of various cellulosic and other fibers that are normally made in the fabrication of tissue products. The useful cellulosic fibers include chemical wood pulp fibers, mechanically produced wood pulp fibers, cotton fibers, and the like. In one preferred example, the paper used to form the thumb protector is one ply of conventional toilet tissue, while the paper used for the continuous length of tissued is three ply. A typical ply is between about 0.005-0.006 inches thick. Each single sheet of toilet paper product can conveniently have a length on the order of 4.0-6.5 inches, preferably approximately four inches, and a width of between 3.5-5.0 inches, preferably about four inches. It will be understood that the dimensions used in this description are intended to be presented by way of example only, since in general, the dimensions are not critical other than, to some extent, the width of the paper roll which would be sized to fit existing paper roll holders.

With respect to the particular example of the improved paper shown in FIG. 2 where the underlying paper is about four inches long by four inches wide, the distance from the pocket edges to the paper edges is about one half inch on either side. The pocket edges 48 are turned under about one quarter inch and pressed to form a border about the pocket. The dotted border (shown generally at 50 in FIG. 2) is intended to represent the edges which are pressed into the underlying paper with a serrated pressure press to affix the top and bottom borders to the underlying paper. By “pressed into” is meant that the top and bottom edges of the paper are pressed, crimped or embossed in some way to make the pocket top and bottom edges adhere to the continuous length of tissue. This could be accomplished, for example, by using a type of commercially available serrated pressure press to adhere the top and bottom pocket edges to the underlying layer of paper. Other attachment schemes could be visualized, as well, including gluing the edges. However, the use of a pressure press is preferred. The length “L” in FIG. 2 is approximately two inches for the size paper illustrated. The length of the paper making up the pocket would be approximately three and one half inches prior to its being folded upon itself to form the crease in the pocket.

In the preferred embodiment, a plurality of the single sheets of paper, attached end wise at the tear away perforations, make up a continuous length of paper, the length of paper being rolled lengthwise around the cylinder 21 to form a roll of the product. The roll of product is separated in use into one or more single sheets by the plurality of perforations that form a plurality of linear tearing portions. This allows the roll of product to be easily torn into the individual single, double or triple sheets having the individual user's preferred length.

An invention has been provided with several advantages. The toilet paper of the invention, provided with thumb receiving pockets, allows the paper to be grasped and used in a new way which more adequately protects the user's hand from contamination during use. The product is simple in design and relatively inexpensive to manufacture. The product also fits conventional, commercially available toilet paper holders/dispensers and is easily substituted for conventional toilet paper.

While the invention has been shown in only one of its forms, it is not thus limited and is susceptible to various changes and modifications without departing from the spirit thereof.

I claim:

1. A toilet paper product designed to be dispensed into the hand of a user, the toilet paper product comprising:
a continuous length of toilet tissue having a first side and an oppositely arranged second side, the continuous length of toilet tissue being wrapped about a cylindrical core to thereby form a roll of toilet paper;
wherein the continuous length of toilet tissue has a series of thumb receiving pockets located at spaced intervals along the first side thereof, whereby upon dispensing a selected length of toilet tissue from the roll, a user's thumb can be placed within a selected pocket with remaining fingers of the user's hand being located behind the selected length of tissue against the second side thereof, so that the user's hand is protected from contamination during use.

2. The toilet paper product of claim 1, wherein the pockets have side edges which define a width measured from the sides of the continuous length of toilet tissue and a length measured along the length of the tissue, and wherein the width of the pockets is less than the width of the continuous length of toilet tissue so that the side edges of the pockets are spaced apart from adjacent edges of the continuous length of toilet tissue.

3. The toilet paper product of claim 2, wherein the continuous length of toilet tissue is divided into individual sheets and wherein the length of the pockets is less than the length of an individual sheet of tissue.

4. The toilet paper product of claim 3, wherein each pocket is partly folded over itself and pressed down flat onto the first side of the continuous length of toilet tissue, whereby each pocket tends to expand into a tent like opening as the toilet tissue is dispensed from the roll.

5. The toilet paper product of claim 4, wherein two different textures of paper are used for the continuous length of tissue paper and the thumb receiving pockets so that the pockets and the continuous length of tissue paper do not tend to mesh together.

6. The toilet paper product of claim 5, wherein the pockets are pressure pressed onto the continuous length of toilet tissue along the side edges thereof with a serrated press in order to hold the pockets onto the continuous length of tissue.

7. The toilet paper product of claim 6, wherein the continuous length of toilet tissue has a plurality of perforations at spaced intervals which form a series of linear tearing portions, allowing the product to be easily torn into desired lengths.

8. The toilet paper of claim 6, wherein the paper making up the thumb receiving pocket is one ply thick while the paper making up the underlying paper length is three plies thick.
